(19) United States
(12) Patent Application Publication
(10) Pub. No.: US 2025/0377668 A1
(43) Pub. Date: Dec. 11, 2025

(54) DECENTRALIZED MULTI-AGENT ACTOR-CRITIC REINFORCEMENT LEARNING MODEL FOR CONTROLLING AUTONOMOUS VEHICLES IN MULTI-VEHICLE ENVIRONMENTS

(71) Applicant: The Boeing Company, Arlington, VA (US)

(72) Inventors: Sean Soleyman, Encino, CA (US); Deepak Khosla, Camarillo, CA (US); Fan Hin Hung, Los Angeles, CA (US); Joshua Gould Fadaie, St. Louis, MO (US); Charles Richard Tullock, St. Peters, MO (US)

(21) Appl. No.: 18/734,767

(22) Filed: Jun. 5, 2024

(51) Int. Cl. G05D 1/698; G05D 1/243; G05D 101/15; G05D 105/35; G05D 109/20

(52) U.S. Cl. CPC G05D 1/6983; G05D 1/243; G05D 2101/15; G05D 2105/35; G05D 2109/20

(57) ABSTRACT

A computerized system configured to execute a multi-agent machine learning model for controlling a plurality of vehicles in a multi-vehicle autonomous control session in a multi-vehicle environment is disclosed. Multi-modal neural network agents of the model each control a corresponding autonomous vehicle in the session. The agents receive image data and parameter data, input the image data to an image feature extractor to produce an image feature vector, input the parameter data to a parameter data feature extractor to produce a parameter data feature vector, produce a joint latent representation of the image data and parameter data, and input the joint latent representation to an actor model neural network, to generate a selected action for the autonomous vehicle. The multi-agent machine learning model is configured to control each autonomous vehicle in the session according to the corresponding selected action for each autonomous vehicle.

### FIELD

This application relates to machine learning, and more specifically to machine learning models that control autonomous vehicles in multi-vehicle environments. In one specific use case, the application relates to using a decentralized multi-agent actor critic reinforcement learning model to control autonomous aircraft in beyond visual range air combat simulations.

### BACKGROUND

The interaction among multiple vehicles in an environment can be simulated by use of computer simulation software. One example of such computer simulation software is the Advanced Framework for Simulation and Modeling (AFSIM), which has been developed to enable users to construct detailed scenarios that replicate real-world environments and missions, of both a commercial and non-commercial nature. The vehicles, which can include aircraft (e.g., unmanned aerial vehicles (UAVs) and manned aircraft), satellites, ground vehicles, etc., have various capabilities. The environments can include complicated terrain and atmospheric conditions, as well as a number of other virtual assets. The process of constructing such a realistic multi-vehicle simulation environment can be complex and time-consuming.

When unmanned vehicles are deployed in real-world scenarios, the unmanned vehicles are typically controlled remotely by human operators. This method of control allows for precise human oversight but also bears significant limitations, particularly in scenarios where communication between the unmanned vehicle and the human operator is disrupted or entirely severed. Such interruptions can be due to various factors including environmental conditions, signal jamming, or the inherent limitations of the communication infrastructure in remote or hostile environments. The reliance on human operators to remotely control these unmanned vehicles involves a substantial commitment of resources and exposes operations to risks associated with delayed or lost communications.

This lack of complete autonomous control capability over unmanned vehicles may be a liability in non-commercial operations, where maintaining operational continuity in communication-compromised scenarios is crucial. Further, in civilian operations as well, the lack of ability of unmanned vehicles to operate independently without human input can increase risk that an operation is not completed on time or correctly. For example, a fleet of remotely controlled UAVs that carry packages for delivery may lose connectivity and deliver their packages to incorrect locations, deliver their packages after delays, or may return to a launch location without performing the deliveries at all. Or, a fleet of UAVs patrolling a forest for instances of wildfire may be unable to complete their patrols, increasing the risk of an unmonitored fire causing damage.

### SUMMARY

In view of the above described issues, a computerized system configured to execute a multi-agent machine learning model for controlling a plurality of vehicles in a multi-vehicle autonomous control session in a multi-vehicle environment is disclosed herein. In one aspect, the multi-agent machine learning model is configured to, at each of a plurality of time steps of the multi-vehicle autonomous control session, at each of a plurality of trained multi-modal neural network agents that each control a corresponding autonomous vehicle in the multi-vehicle autonomous control session: (a) receive multi-modal vehicle state data including image data and parameter data; (b) input the image data to an image feature extractor of the multi-modal neural network agent to thereby produce an image feature vector; (c) input the parameter data through a parameter data feature extractor of the multi-modal neural network agent to thereby produce a parameter data feature vector; (d) concatenate the image feature vector and parameter data feature vector to thereby produce a joint latent representation of the multi-modal vehicle state data; and (e) input the joint latent representation to an actor model neural network of the multi-modal neural network agent, to thereby generate a selected action for the autonomous vehicle. The multi-agent machine learning model is configured to, at each of a plurality of time steps, control each autonomous vehicle in the multi-vehicle autonomous control session according to the corresponding selected action for each autonomous vehicle.

### BRIEF DESCRIPTION OF THE DRAWINGS

FIG. 1 shows a schematic view of a computing system configured to execute a multi-agent machine learning model for controlling a plurality of vehicles in a multi-vehicle autonomous control session in a multi-vehicle environment, according to one example implementation of the present disclosure.

FIG. 2 is a detail schematic view of simulation logic of the computing system of FIG. 1.

FIG. 3 is a schematic view of an autonomous vehicle configured to execute a trained multi-modal neural network agent that has been trained by the computing system of FIG. 1.

FIG. 4 is a detail view of an architecture of the multi-modal neural network agent of the computing system of FIG. 1.

FIG. 5 is an example of tabular parameter data included in input to the multi-modal neural network agent of the computer system of FIG. 1.

FIG. 6 is an example of image data included in input to the multi-modal neural network agent of the computer system of FIG. 1.

FIG. 7 is a schematic view showing aggregation of multiple images to form the image data input to the multi-modal neural network agent of the computer system of FIG. 1.

FIG. 8 is a schematic view at inference time of multiple aircraft being controlled in a decentralized manner by respective actors of respective multi-modal neural network agents of the computer system of FIG. 1.

FIG. 9 is a schematic view of a training configuration used to train the multi-modal neural network agents of the computer system of FIG. 1.

FIG. 10 is a view of a flow chart of a method for executing a multi-agent machine learning model for controlling a plurality of vehicles in a multi-vehicle autonomous control session in a multi-vehicle environment, according to one example of the present disclosure.

FIG. 11 is a graph of win percentages of an artificial intelligence model, i.e., the multi-agent machine learning model of the computing system of FIG. 1, in various simulations against expert systems controlled aircraft, using simulated non-fuzzy sensors to train the model.

FIG. 12 is a graph of win percentages of an artificial intelligence model, i.e., the multi-agent machine learning model of the computing system of FIG. 1, in various simulations against expert systems controlled aircraft, using simulated fuzzy sensors to train the model.

FIG. 13 shows a schematic view of an example computing environment in which the computing system of FIG. 1 may be enacted.

### DETAILED DESCRIPTION

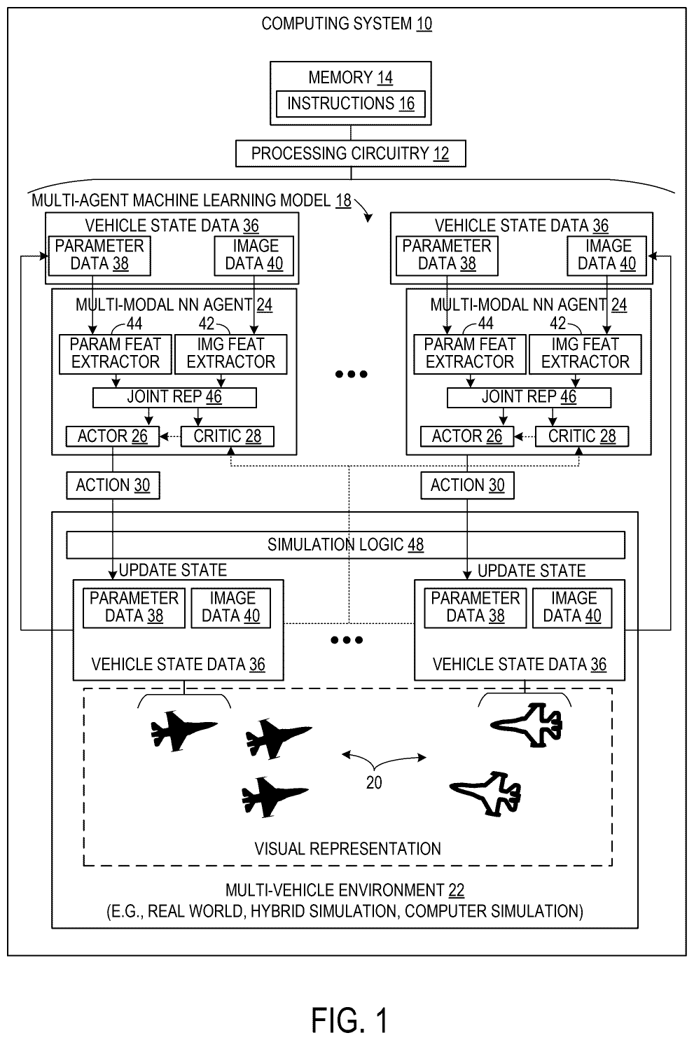

As shown in FIG. 1, to address the issues described above, a computing system 10 is provided that implements a multi-agent decentralized actor critic reinforcement learning model for controlling autonomous vehicles in a multi-vehicle environment. While the actor is decentralized, the critic may be centralized or decentralized, as described below. The computing system 10 includes processing circuitry 12 and associated memory 14 storing instructions 16 that when executed by the processing circuitry 12 cause the processing circuitry 12 to perform the functions described below.

The processing circuitry 12 is configured to execute a multi-agent machine learning model 18 for controlling a plurality of vehicles 20 in a multi-vehicle autonomous control session in a multi-vehicle environment 22. The multi-agent machine learning model 18 includes a plurality of multi-modal neural network agents 24, each of which includes an actor model 26 (hereinafter, actor) and a critic model 28 (hereinafter, critic). Both the actor 26 and critic 28 include respective neural networks. The actor neural network learns a policy (represented in the learned weights of the actor neural network) to predict actions 30 based on inputs, while the critic 28 positively rewards the actor 26 when the predictions have a high utility, and negatively rewards the actor 26 when the predictions have low utility, and learns a utility network that predicts the value of actions 30 chosen by the actor 26. In one embodiment the critics 28 are centralized and communicate with each other to predict global utility across the actions 30 of all actors 26 in multi-vehicle environment 22, and in another embodiment the critics 28 are decentralized and learn their value policies based solely on the actions 30 of their respective actor 26.

It will be appreciated that the multi-agent machine learning model 18 runs in a loop over a series of timesteps throughout the autonomous control session. During training, at each timestep the actor 26 predicts an action 30 based on its learned policy to that point, and the critic 28 evaluates a centralized (or alternatively decentralized) utility based on the actions 30 of other actors 26 of other agents 24 (or alternatively based on the actions of its corresponding actor 26 alone), and generates a reward for the corresponding actor 26, which is used to train the actor 26 to favor or disfavor the previously taken action under similar conditions.

The simulation proceeds with two nested loops: a first outer loop through a plurality of time steps of the multi-vehicle autonomous control session, and a second inner loop through each of the plurality of multi-modal neural network agents 24 that each control a corresponding autonomous vehicle in the multi-vehicle autonomous control session. Thus, at each time step, each agent 24 predicts an action 30 for its corresponding vehicle 20, and during training, that action 30 is evaluated by the critic 28 using centrality information from other actors, that is, information on the actions 30 taken by other actors and the state of the multi-vehicle environment 22 as a whole. Alternatively, utility can be computed in a decentralized manner using only information available for each vehicle 20 to the critic 30 of each agent 24.

The vehicle state of each vehicle 20 is represented by vehicle state data 36. The processing circuitry 12 is configured to receive multi-modal vehicle state data 36 including image data 40 and parameter data 38; input the image data 40 to an image feature extractor 42 of the multi-modal neural network agent 24 to thereby produce an image feature vector; input the parameter data 38 through a parameter data feature extractor 44 of the multi-modal neural network agent 24 to thereby produce a parameter data feature vector; concatenate the image feature vector and parameter data feature vector to thereby produce a joint latent representation 46 of the multi-modal vehicle state data 36; and input the joint latent representation 46 to the actor model neural network 26 of the multi-modal neural network agent 24, to thereby generate a selected action 30 for the autonomous vehicle 20, for that timestep. The processing circuitry 12 is further configured to control each autonomous vehicle 20 in the multi-vehicle autonomous control session according to the corresponding selected action 30 for each autonomous vehicle 20. During training the joint representation 46 is also passed to the critic 28 to use as it learns its utility policy function.

The parameter data 38 can include three dimensional position, heading, and speed for each vehicle 20, for example. The speed may be ground speed and/or air speed, for example. The three dimensional position, heading and speed information can be generated using sensor fusion techniques blending GPS sensor readings, accelerometer readings, speedometer readings, lidar readings, and readings from other sensors, etc. It will be appreciated that this parameter data is parameterized and represented as numeric values. In some examples, the parameter data may be in table format and thus may be referred to as tabular data. In addition, the parameter data may include other data from vehicle subsystems such as non-commercial subsystems, navigations subsystems, propulsion subsystems, sensor subsystems, etc. These parameter data are typically generated by simulation logic 48. However, in a hybrid simulation, one or more of the vehicles may be a real world vehicle and the parameter data may be generated by on-board sensors on the vehicle.

One particular sensor signal representation that is useful in beyond visual range air combat and other multi-vehicle simulations is a sensor certainty map, which represents the probability of accurate detection of other vehicles within the map. Accordingly, the image data can include a sensor certainty map for a sensor of the vehicle. In one example implementation a plurality of sensor certainty maps are included in the image data, each for a respective sensor of the vehicle. These sensor maps can be overlaid on each other using transparent overlays to give a pixel-wise estimate of the certainty at a given distance and direction from the vehicle. Examples of these sensor certainty maps are discussed further below.

A variety of actions 30 are possible in the simulation. Where the simulation is an air combat simulation, such as beyond visual range air combat, the action can be selected from the group of candidate actions consisting of a flight control action, deployment action, and countermeasure action. The flight control action can include an aircraft maneuver such as pursuit, dynamic route vectoring, aircraft evasion, and missile evasion, as some examples. The countermeasure can includes launching flares and chaff, for example.

As discussed above, the session can be a computer simulation, a hybrid simulation with some simulated vehicles and some real vehicles, or a session in a real world environment with real vehicles. When a centralized critic approach is adopted, each multi-modal neural network agent 24 further includes a centralized critic neural network 28 that is configured to train the corresponding actor neural network 26 by computing a corresponding centralized action-value for the selected action of each actor neural network using a centralized action-value function that takes as input the actions of each actor neural network 26 of each of the plurality of agents 24. In one specific example, the vehicles 20 can be aircraft and the multi-vehicle environment can be a beyond visual range air combat simulation.

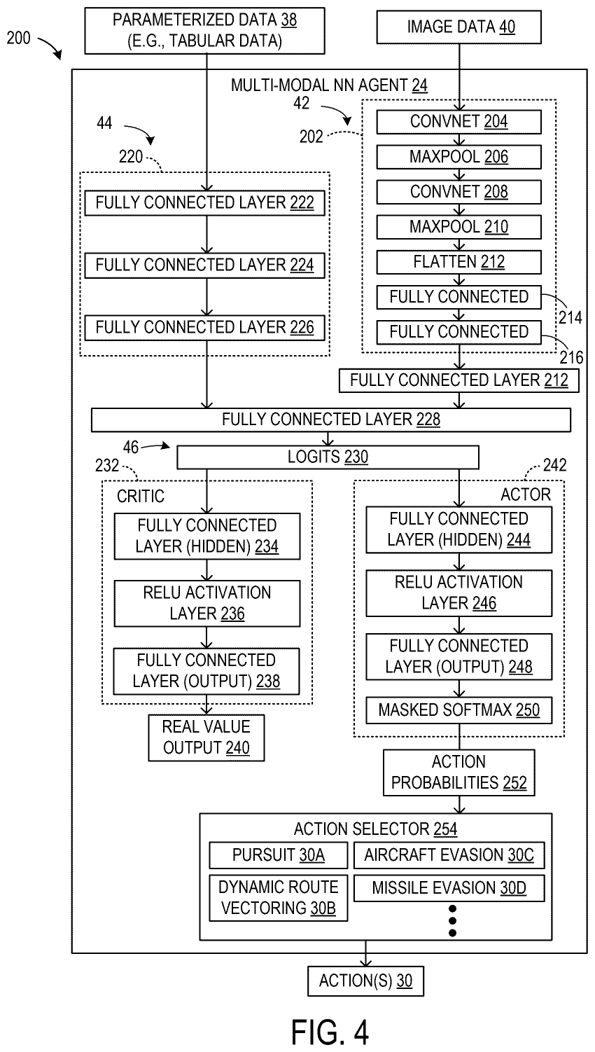

As discussed in relation to FIG. 4 below, the parameter feature extractor 44 can be a trained neural network that includes a plurality of fully connected layers. The image feature extractor 42 can be a trained neural network that includes, from input to output, one or more convolutional layers, a pooling layer, one or more additional convolutional layers, another pooling layer, one or more fully connected layers, and a fully connected output layer.

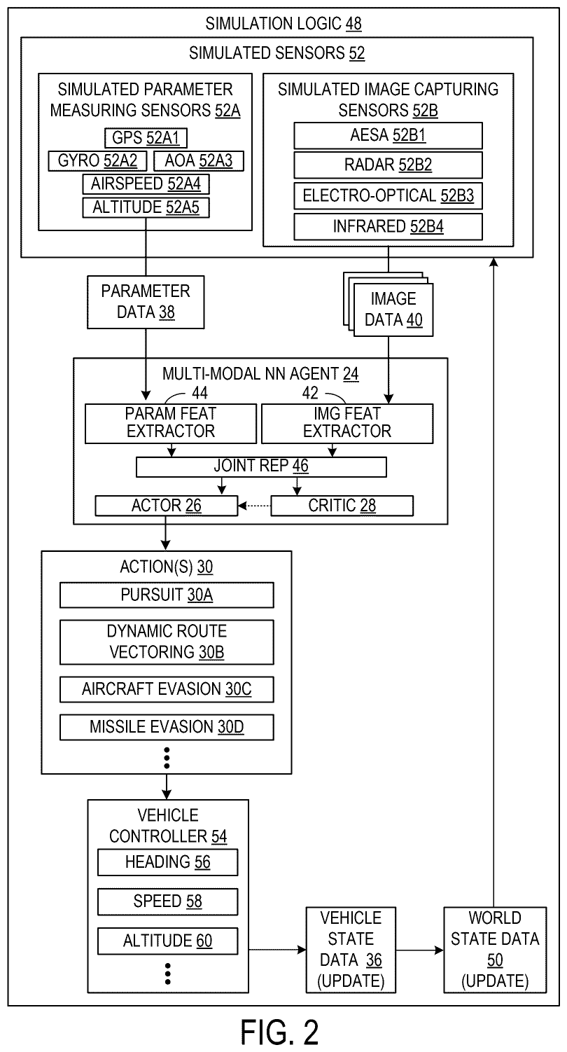

FIG. 2 illustrates the simulation logic 48 in detail. As shown and described above, for each vehicle, at each time step in the simulation, simulation logic 48 proceeds in a simulation loop for each vehicle. The simulation logic 48 maintains vehicle state data 36 for each vehicle, and world state data 50 for the environment 22 as a whole. To simulate the vehicle's perceptions of the environment 22 and other vehicles 20 in the environment, the simulation logic 48 includes simulated sensors 52 for each vehicle. The world state data 50 is provided to simulated sensors 52, and at each time step each simulated sensor 52 outputs data similar to a real sensor in view of the world data 50. Among the simulated sensors, simulated image capturing sensors 52A and simulated parameter capturing sensors 52B are provided. The simulated image capturing sensors include simulated active electronically scanned array (AESA) radar sensors 52B1, simulated targeting radar 52B2, simulated electro-optical sensors (e.g., visible light cameras) 52B3, and simulated infrared sensors 52B4, and/or other types of simulated sensors that output images. In one example simulation scenario, each of these image capturing sensors is configured to generate a sensor certainty map, indicating a certainty with which it can detect a vehicle at a particular distance. As for the simulated parameter measuring sensors 52A, simulated global positioning satellite system sensors 52A1, simulated gyroscopes 52A2, simulated angle of attack sensors 52A3, simulated airspeed sensors 52A4, and simulated altitude sensors 52A5, etc., are provided. In some embodiments, a sensor fusion module can be provided to estimate a reduced set of parameters, such as heading, speed, and altitude, from these simulated parameter measuring sensors 52A. The data from simulated parameter measuring sensors 52A is sent to the multi-modal neural network agent 24 as parameter data 38. The multi-modal neural network agent 24 functions as described above and will not be redescribed.

The actor 26 predicts an action 30, such as pursuit 30A, dynamic route vectoring 30B, aircraft evasion 30C, missile evasion 30D, etc. The action is passed to a vehicle controller 54. The vehicle controller 54 is configured to make decisions regarding the route of the vehicle 20, and compute flight control parameters such as heading 56, speed 58, and altitude 60, to control the trajectory and speed of the vehicle, based on the action 30. Values for the heading 56, speed 58, and altitude 60 are passed to the vehicle state data, and these values and the position of the vehicle are updated. The updated vehicle state data 36 is passed to the world state data, where interactions between the vehicles are checked, such as collision detection, etc.

In addition to using simulated sensors 52, data collected from aircraft during exercises can be used for the parameter data 38 and image data 40, in some implementations. Further, the sensors collecting parameter data 38 and image data 40 can be on another aircraft, a ground installation or vehicle, or a satellite, in some implementations.

Either of the parameter data 38 or image data 40 may be run through post processing prior to input to the multi-modal neural network agent 24. For example, The processing circuitry 24 executes implement a Kalman Filter or an Extended Kalman Filter, to filter and denoise the state and parameter data 28 and the image data 30. The sensor data post-processing prior to input to the agent 24 may be configured to filter or select for the relevant data, normalize the data, and calculate the validity of any preconditions necessary to enable the execution of actions 30 selected by the actor 26.

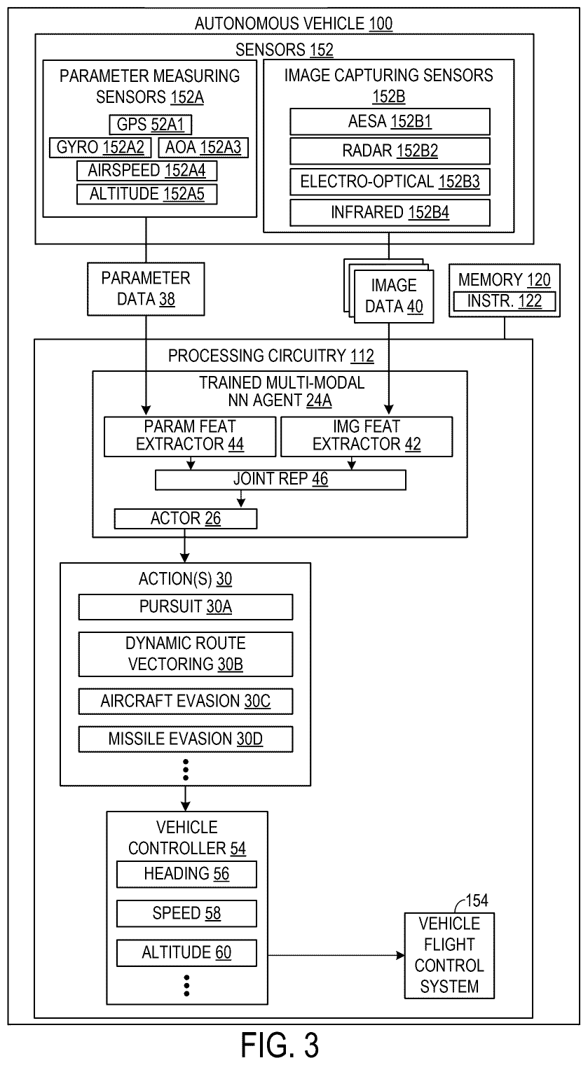

As shown in FIG. 3, after training is complete, the trained multi-modal model 24A can be executed using processing circuitry 124 and associated memory 120 and instructions 122 of an autonomous vehicle 100, such as a UAV. The autonomous vehicle 100 includes sensors 152 including parameter measuring sensors 152A configured to measure real world phenomena and output parameters. These sensors 152A include a GPS 152A1, gyroscope 152A2, angle of attack sensor 152A3, airspeed sensor 152A4, and altitude sensor 152A5, among others. Further, image capturing sensors 152B include AESA radar 152B1, radar 152B2, electro-optical imaging sensor (e.g., visible light camera) 162B3, infrared sensor 152B4, among others. These sensors 152A, 152B are configured to measure real world phenomena from the vehicle, and may be combined or replaced with offboard sensors on other vehicles, ground equipment, or satellites.

Regarding image data 40, the image capturing sensor 152B (or simulated image capturing sensor 52B described above) can be configured to capture an image of an object or portion of the environment, perform object detection to crop the captured images to a region of interest, and thereby generate a plurality of cropped images including detected objects. The image feature extractor 42 can be executed on the cropped images, to extract features, execute a clustering model configured to cluster the plurality of cropped images of the image data 40 into a plurality of feature clusters based on similarities of the extracted features to each other, label a plurality of target clusters of the plurality of feature clusters and a plurality of cropped images of the plurality of target clusters with respective predetermined object labels, generate a training dataset including the plurality of cropped images of the plurality of target clusters, and train an object detection machine learning model using the training dataset to predict an object label for an inference time image at inference time. The respective predetermined object labels of the plurality of target clusters correspond to prediction object labels of the object detection machine learning model configured to recognize elements of the object or the environment. An object detection machine learning model trained in this way can be used as the image feature extractor 42.

Upon receiving the parameter data 38 and image data 40, the trained multi-modal neural network 24A is configured to output a predicted action 30 with the highest predicted utility, of the types previously discussed. The predicted action 30 can be sent to a vehicle controller 50.

The selectable actions 30A-30D may be defined as an action space, in which invalid options are masked out by a [0,1] Boolean-mask vector of the same size as the action space. The number of selectable actions 30A-30D is not limited to four; rather, any number greater than four is also contemplated. The one or more actions 30 are executed by the vehicle controller 54 to control the vehicle 20. The vehicle controller 54 can control a heading 56, speed 58, altitude 60, and other properties of the vehicle to carry out the selected actions 30. A rules-based script can be associated with each selected action 30 to determine the maneuver that is executed by the vehicle. These parameters are output to the vehicle flight control system 154, as inputs, to aid in autonomous flight. In this way, even if a UAV being remotely piloted by a human pilot loses communication with the remote pilot, the UAV can continue flying under the control of the trained multi-modal neural network agent 24A. Further, fully autonomous flight may also be possible using the trained multi-modal neural network agent 24A.

Turning now to FIG. 4, a deep neural network architecture 200 of the multi-modal neural network actor 24 of FIG. 1 is described in further detail. The deep neural network architecture 200 receives both parameter data 38 such as tabular data, and image data 40, as shown. Two different neural network channels 202, 220 (corresponding to image feature extractor 42 and parameter data feature extractor 44 discussed above) handle the different types of data: the visual neural network channel 202 handles the image data 40, while the parameter data neural network channel 220 handles the parameter data 38. Outputs from the visual neural network channel 202 and the parameter neural network channel 220 are first concatenated and then passed through final fully connected layer 228. The final fully connected layer 228 outputs numerical value logits 230 (corresponding to joint representation 46 discussed above) that are passed as inputs to an actor model 242 and a critic model 232, corresponding to the actor 26 and critic 28 discussed above. The actor model 242 and the critic model 232 comprise one to or more neural network layers.

The inputted parameter data 38 and image data 40 are first passed through a series of stacked neural layers in the parameter data neural network channel 220 and the visual neural network channel 202, respectively. The visual neural network channel 202 receives the image data 40, which describes perceived aspects of the environment from the perspective of the vehicle 20. The image data 40 can be provided as three separate images, in one specific example. For example, the first image can show perceived and assumed enemy sensor coverage, the second image can show friendly sensor coverage, and the third image can show the sensor coverage of the vehicle. Each image is separately passed through the visual channel neural network 202. Thus, the structure of the visual channel neural network channel 202 can be duplicated, triplicated, or more to accommodate the separate images of the image data 40. Accordingly, when the image data 40 comprises five separate images, the visual channel neural network channel 202 may be instantiated as five separate channels for receiving each separate image of the image data 40, such that the number of separate images in the image data 40 matches the number of channels in the visual channel neural network channel 202. The three outputs from the visual channel neural network 202, one collection of outputs per image, can be concatenated and then passed through a fully connected layer 218 before merging with the output from the parameter data neural network channel 220.

In the visual neural network channel 202, the image data 40 is first processed by the first convolutional layer 204, which may apply a series of filters to detect low-level features such as edges and textures. Following the first convolutional layer 204, the first max pooling layer 206 reduces the spatial dimensions of the feature maps, thereby abstracting the extracted low-level features. The output from the first max pooling layer 206 is processed by a second convolutional layer 208 which captures more complex features in the image data 40. The second max pooling layer 210 further reduces the dimensionality of the image data 40. After the final pooling layer 210, the image data 40 is flattened in the flatten layer 212 from a multi-dimensional tensor into a one-dimensional vector. The flattened data passes through multiple fully connected layers 214, 216, 218, thereby learning non-linear combinations of the high-level features extracted from the previous layers 204-212.

In the parameter data neural network channel 220, the parameter data 38 is directly fed into multiple fully connected layers 222, 224, 226, thereby finding complex patterns and relationships between the features of the parameter data 38. Both the image and parameter streams converge into a shared fully connected layer 228, which combines the learned features from both channels 202, 220 to produce one or more vectors of logits 230 (corresponding to joint representation 46 discussed above) which can be used to predict a high level action 30A-30D of highest utility.

The logits 230 are passed to the actor model 242, which produces a plurality of action probabilities 252 for generating one or more actions 30, and a critic model 232. The actor model 242 and the critic model 232 can share the weights from the stacked neural layers in the visual neural network channel 202 and the tabular neural network channel 220, or have separate weights from the rest of the deep neural network architecture 200.

In the critic model 232, the one or more vectors of the logits 230 along with one or more identically shaped vectors of high level action masks are passed through a fully connected hidden layer 234, a ReLU activation layer 236, and a fully connected output layer 238 which generates a single real-value output 240, which may be an estimate of the utility of the current environmental state. The critic model 232 may take into account the actions of other actors in other agents for other vehicles, and thus may be a centralized critic, when making this determination, or may only take into account local information, thus acting in a decentralized manner.

In the actor model 242, the one or more vector of the logits 230 along with one or more identically shaped vectors of high level action masks are passed through a fully connected hidden layer 244, a ReLU activation layer 246, and a fully connected output layer 148 before being combined via a masked softmax operation 250. The action masks indicate which actions are allowable or legal at any given timestep. The masked softmax operation 250 produces non-zero action probabilities 252 for selecting the high level actions or behaviors that are legal or valid.

The action selector 254 executes another mathematical operation to selects the one or more actions 30 with the highest probability specifically, or samples the one or more possible actions 30A-30D according to the action probabilities 252. These high level actions 30 are then used to select one to several lower level actions by the vehicle controller 54, discussed above, which may execute these lower level actions as rules-based maneuvers that control the vehicle. These rules-based maneuvers ultimately provide vehicle controls such as heading 56, speed 58, and altitude 60 changes to the vehicle. Rules-based maneuvers can cause the vehicle to execute the selected one or more high-level actions 30.

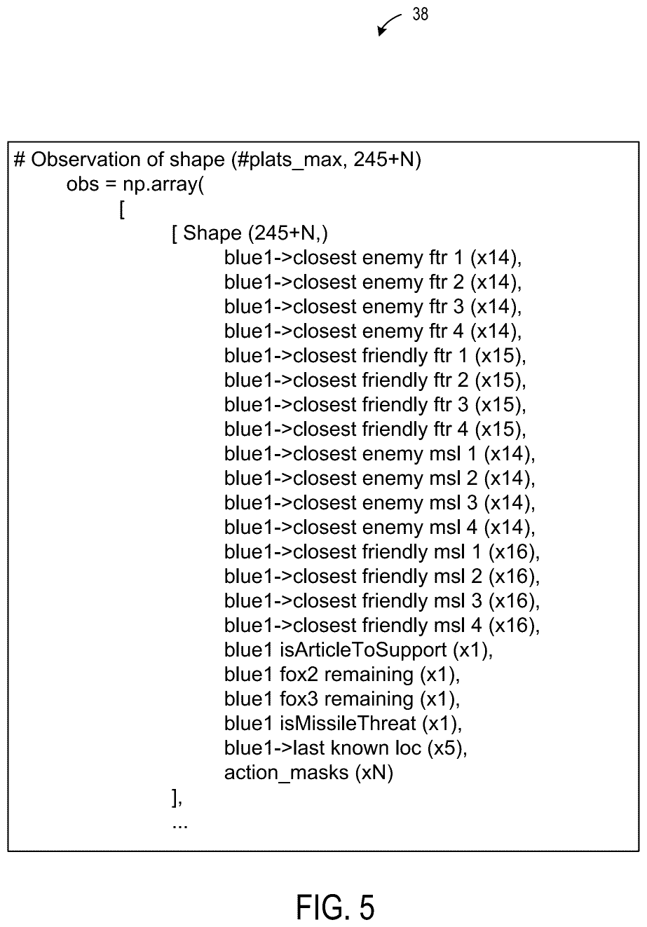

Referring to FIG. 5, an example is depicted of parameter data 38 in tabular form that can be inputted into the multi-modal neural network agent 24 discussed above. In this example, the tabular data provides relational track data of closest friendly fighters (‘friendly ftr’), closest enemy fighters (‘enemy ftr’), closest friend missiles (‘friendly msl’), and closest enemy missiles (‘enemy msl’). The track data can provide additional information such as relative heading differences, relative bearing differences, relative x, y, z speeds (speeds in each dimension in a three dimensional space), relative altitudes, and relative down and cross ranges. Boolean event indicators are also provided, such as whether a non-commercial article is in need of fighter sensor support (‘isArticleToSupport’), whether an incoming missile is a threat (‘isMissileThreat’) and other status indicators. The action masks information (‘action_masks (xN)’) is a vector of length N and contains a Boolean-mask of valid actions for the individual vehicle platform.

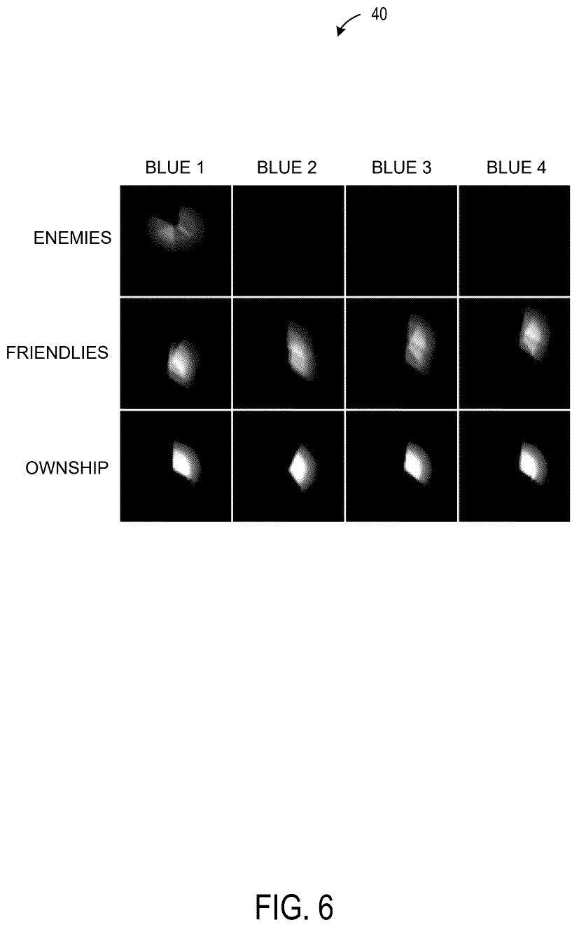

Referring to FIG. 6, an example is depicted of image data 40 inputted into the multi-modal neural network agent 24. In this example, the image data 40 depicts an engineered representation of the perceived environment, visualizing the perceived sensor areas of friendly aircraft, enemy aircraft, and ownship aircraft in snapshots of three images perceived by four blue aircraft. For each blue aircraft, there is one image for enemy aircraft, one image for friendly aircraft, and one image for itself (ownship). The images in FIG. 6 are examples of sensor certainty maps, showing a degree of certainty of detection at a distance from each vehicle.

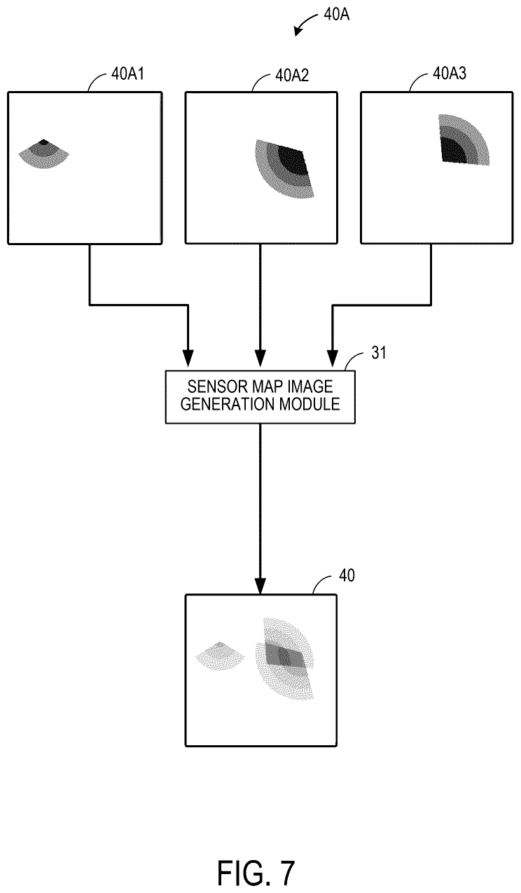

Referring to FIG. 7, the relevant raw visual data 40A from aircraft sensors and on-board devices can be transformed via a custom visualization function. Images 40A1, 40A2, and 40A3 of simulated image capturing sensors 152B depicted for the perceived platforms in the visual data can be assumed to have a particular shape and probability of detection curve. Sensors can be rotated and translated according to the spatial relationships of other vehicles relative to the vehicle by the vehicle controller 54. Individual sensors for each sensor type on each vehicle can be approximated via a series of arcs with start and stop angles. The color/brightness of the arcs can indicate the probability of platform detection by the sensor. Arcs can be overlaid to create a sensor detection band associated with different probabilities. A data fusion module such as the sensor map image generation module 31 can combine the various images 40A1-A3 of the sensors in the visual data 40A into a single image in the final image data 40 to provide an aggregate enemy and friendly sensor coverage map. The images 40A1-A3 of various sensors can be combined via mean aggregation, such that areas where multiple sensor overlap are darker or lighter in value. Areas where sensors overlap have a higher probability of detection. Differences in pixel values thus provide the multi-modal neural network agent 24 inputs upon which predictions can be made.

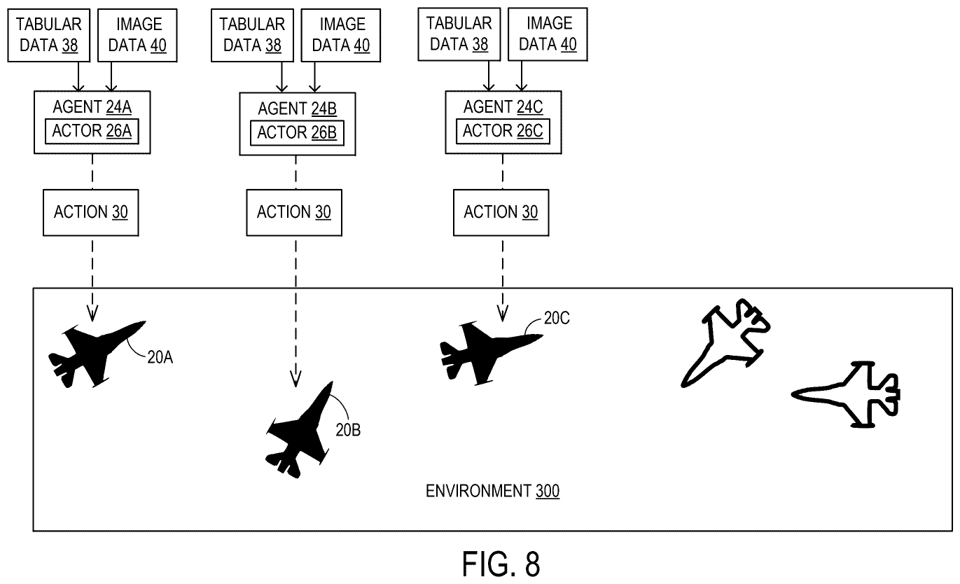

FIG. 8 illustrates an exemplary environment 300 in which multiple vehicles and vehicle platforms operate autonomously, each managed by its own trained multi-modal neural network agent 24A-24C. In this configuration, each vehicle 20A-20C is equipped with a corresponding actor 26A-26C that independently determines the actions 30 that the vehicle will execute, allowing for greater scalability and flexibility in system implementation. This configuration is especially advantageous in scenarios where communication is limited or entirely absent, enabling vehicles to operate autonomously and make independent decisions.

At inference time, in a real world deployment, each vehicle's multi-modal neural network agent 24A-24C receives both tabular data 38 and image data 40 from on-board sensors as shown in FIG. 3 and described above. The multi-modal neural network agents 24A-24C process and respond to the parameter data 38 and image data 40, ensuring that each vehicle can formulate and execute its own actions 30 based on data that includes, but is not restricted to, information from its own onboard sensors 152.

The configuration depicted in FIG. 8 ensures that each vehicle retains the capability to adapt and react to dynamic environmental changes and other vehicular behaviors without reliance on centralized command or continuous communication with other vehicles. This autonomy is important in environments where real-time data transmission may be compromised or unavailable. By decentralizing control and data processing, the system enhances robustness and reliability, providing each vehicle with the tools necessary to navigate complex scenarios effectively and efficiently.

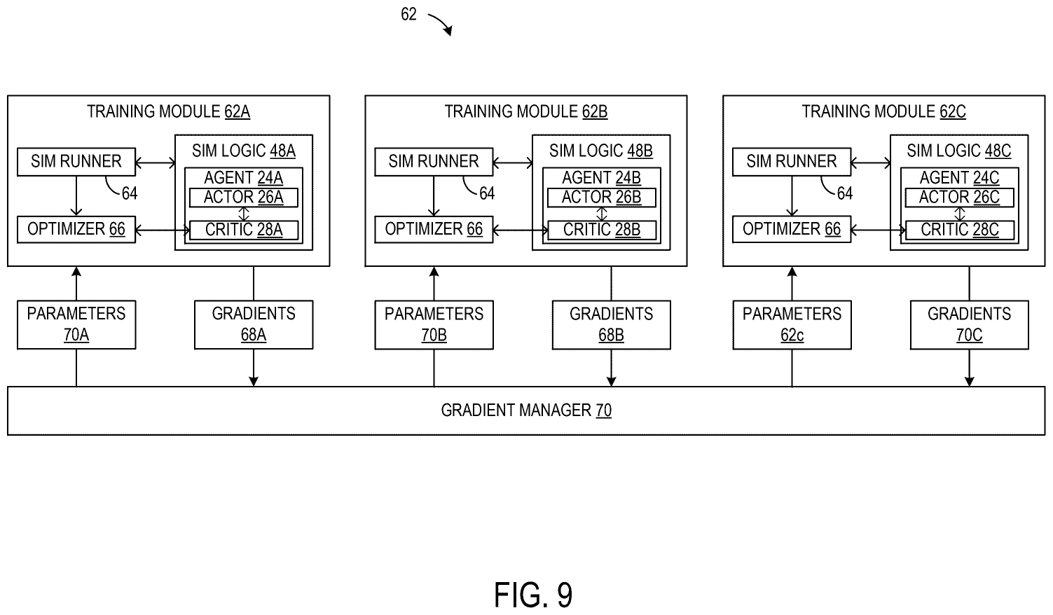

Turning to FIG. 9, an exemplary set of training modules 62 implemented by the computing system 10 is shown, which are used to train the multi-modal neural network agents 24A-24C. The first training module 62A is configured to train the multi-modal neural network agent 24A, the second training module 62A is configured to train the multi-modal neural network agent 24B, and the third training module 62C is configured to train the multi-modal neural network agent 24C.

Each training module 62A-62C includes a simulation runner 54 that executes a multi-vehicle simulation session over a specified number of frames or steps. During these simulations, the multi-modal neural network agents 24A-24C interact dynamically with the simulated environment. The actors 26A-26C of each of the agents 24A-26C predicts an action using locally available information (parameter data 38 and image data 40), and the critics 28A-28C of each of the agents 24A-24C shares the actions of the local actor with the other critics, and computes a reward value for the local actor 26A-26C based on a global utility value computed using the gradient manager 70. Performance data which is subsequently used to refine and optimize the multi-modal neural network agents 24A-24C through a series of gradient calculations performed by an optimizer 66. The gradient calculations can implement proximal policy optimization (PPO), for example, updating the actors 26A-26C by calculating gradients 68A-68C that measure the necessary adjustments to improve decision-making capabilities of the actors 26A-26C.

The optimization cycle within each training module 62A-62B is autonomous, allowing each to run simulations, collect data, and execute optimizations according to its own schedule. Once all training modules 62A-62B complete their individual tasks, a gradient manager 70 aggregates the gradients from each training module 62A-62C. This aggregation can involve averaging, summing, or other mathematical operations to aggregate the collected data effectively. Responsive to performing the aggregation, the gradient manager 60 then respectively sends parameters 70A-70C to each of the training modules 62A-62C, so that the optimizer 66 can run optimizations to enhance the performance of the actors 26A-26C. Training modules 62 configured in this way can implement decentralized actor centralized critic training.

The simulations run by the simulation runner 64 can be competitive, where each actors 26A-26C competes against rules-based logic or an artificial intelligence adversary. This configuration can foster the emergence of novel actions and strategies, enhancing the adaptability and robustness of the actors 26A-26C. Through these competitive simulations, actors 26A-26C are incrementally rewarded or penalized based on their performance, with rewards systems configured as either sparse or dense. Sparse rewards provide feedback at the end of each multi-vehicle simulation session, based on outcomes like wins, losses, or draws, while dense rewards offer continuous feedback for actions such as successfully evading a missile, reflecting a more granular assessment of performance.

The termination conditions for these simulations can be diverse and can be adjusted based on various factors like the status of combat elements (e.g., number of remaining aircraft, number of remaining missiles) or operational limits such as timeouts and boundary conditions. These conditions ensure that each simulation session is bounded and measurable, contributing to the precise calibration of action selectors through performance incentives that ultimately increase the likelihood of selecting advantageous actions and minimize the risk of detrimental ones.

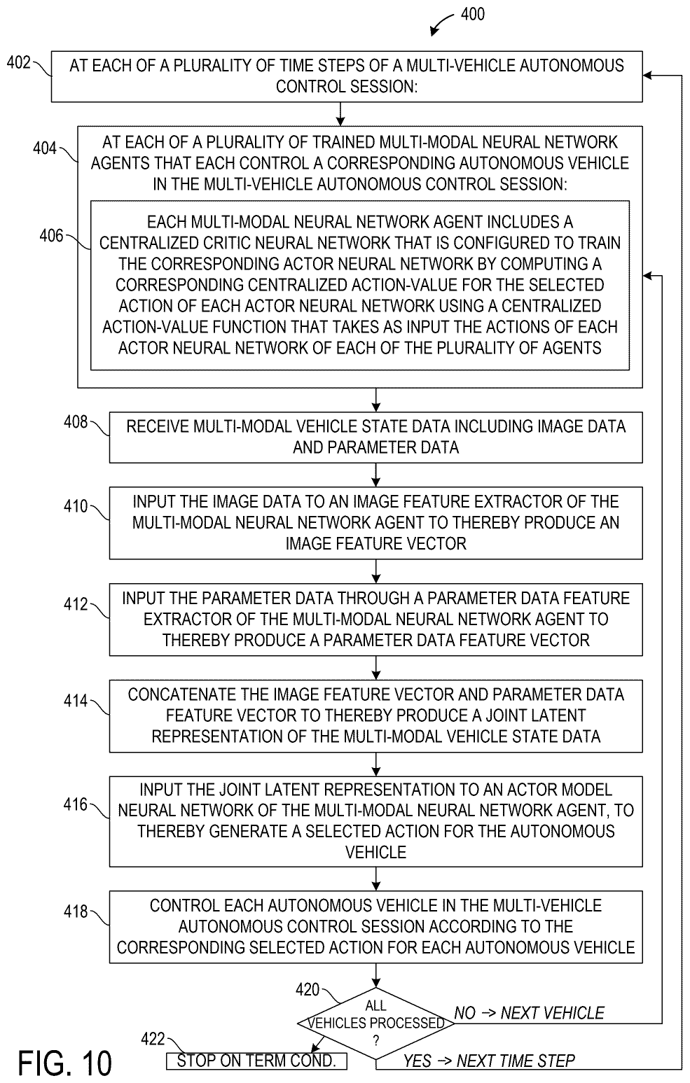

FIG. 10 is a flowchart that illustrates a method 400 for use in controlling vehicles in a multi-vehicle environment. The method 400 can be implemented on the computing system 10 as described above, which includes processing circuitry and associated memory configured to perform the processes of method 400. Alternatively, other suitable computing hardware and software may be utilized.

Method 400 loops through two nested loops. In a first loop illustrated at 402, at each of a plurality of time steps of a multi-vehicle autonomous control session the method loops through steps 404 to 420. The session can be of a computer simulation, a hybrid simulation with some simulated aircraft and some real-world aircraft, or a session of exclusively involving real world aircraft. In one specific example session, the vehicles are simulated aircraft and the multi-vehicle environment is a beyond visual range air combat simulation. In a second, nested loop at 404, at each of a plurality of trained multi-modal neural network agents that each control a corresponding autonomous vehicle in the multi-vehicle autonomous control session, the method loops through steps 404 through 420. As shown at 406, each multi-modal neural network agent can include a centralized critic neural network that is configured to train the corresponding actor neural network by computing a corresponding centralized action-value for the selected action of each actor neural network using a centralized action-value function that takes as input the actions of each actor neural network of each of the plurality of agents.

Within the nested second loop, at 408, the method includes receiving multi-modal vehicle state data including image data and parameter data. The image data may be from image capturing sensors, and the parameter data may be parameter measuring sensors on-board the vehicle, other vehicles in the simulation, ground equipment, or satellites, for example. The image data can include a sensor certainty map for one or more sensors of the vehicle, in one example. The parameter data can include three dimensional position, heading, and speed for each vehicle. Additionally, the parameter data can include vehicle subsystem information, such as non-commercial article state and range. As described above, this data may be directly measured from sensors, generated by simulated sensors in the simulation environment, and may be postprocessed via filtering, denoising, etc., via a Kalman or Extended Kalman filter, or other suitable process, prior to input to the multi-modal neural network agent.

At 410, the method includes inputting the image data to an image feature extractor of the multi-modal neural network agent to thereby produce an image feature vector. As described above, the image feature extractor can be a neural network with a one or more convolutional layers and one or more fully connected layers. In one example, the image feature extractor includes, from input to output, one or more convolutional layers, a pooling layer, one or more additional convolutional layers, another pooling layer, one or more fully connected layers, and a fully connected output layer

At 412, the method includes inputting the parameter data through a parameter data feature extractor of the multi-modal neural network agent to thereby produce a parameter data feature vector. The parameter feature extractor may also be a neural network including one or more fully connected layers.

At 414, the method includes concatenating the image feature vector and parameter data feature vector to thereby produce a joint latent representation of the multi-modal vehicle state data. At 416, the method includes inputting the joint latent representation to an actor model neural network of the multi-modal neural network agent, to thereby generate a selected action for the autonomous vehicle. The action can be selected from the group of candidate actions consisting of a flight control action such as a maneuver command, deployment action such as firing a missile, and countermeasure action such as launching flares and chaff from an aircraft. The flight control action can include includes pursuit, dynamic route vectoring, aircraft evasion, and missile evasion, for example.

At 418, the method includes controlling each autonomous vehicle in the multi-vehicle autonomous control session according to the corresponding selected action for each autonomous vehicle. The control can be implemented by a vehicle controller configured to receive the selected action and output heading, speed and altitude parameters for a flight control system to receive as inputs.

At 420 the method includes determining if all vehicles have been processed by their respective multi-model neural network agents in the inner nested loop, and if not, looping back up to step 404. If all vehicles have been processed, the method proceeds to loop back to step 402. The session proceeds until a termination condition, such as those described above, is detected at 422, at which point the session is terminated.

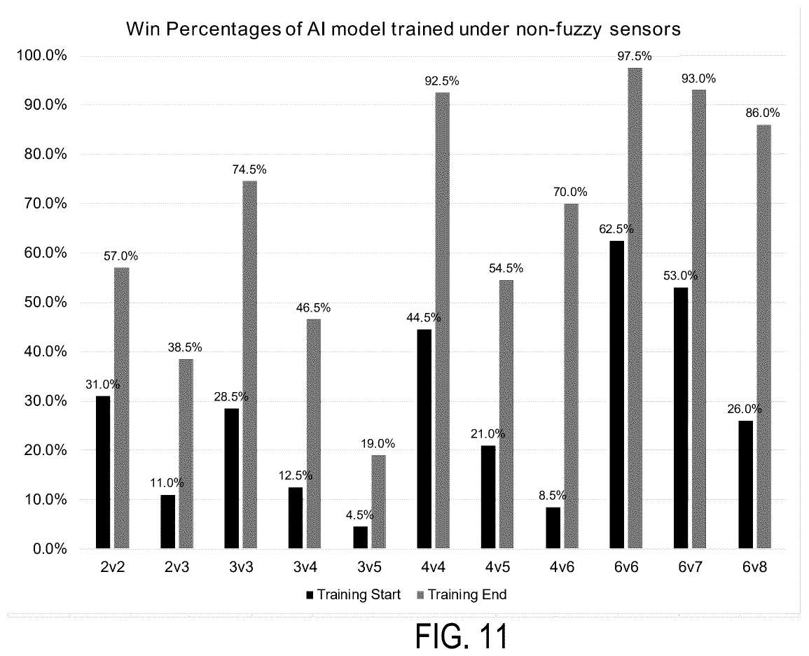

FIG. 11 shows a bar graph detailing the performance improvements achieved by the multi-modal neural network agents 24 of the computing system 10 described above, through the course of training in various combat simulation scenarios utilizing simulated non-fuzzy sensors, which are simulated sensors that provide precise and unambiguous data. The scenarios range from evenly matched configurations (for example, 2v2, where two friendly vehicles combat two enemy vehicles) to more challenging configurations (for example, 6v8, where six friendly vehicles face eight enemies). Each configuration was evaluated to illustrate the evolving efficacy of the autonomous systems in combat simulations.

The graph in FIG. 11 highlights the progression in win rates across different configurations from the beginning to the end of the training phase. For instance, in the 2v2 configuration, the initial win rate was 31.0%, which increased to 57.0% by the end of training, indicating a substantial increase in the system's decision-making and combat strategies. Similarly, more challenging scenarios like the 2v3configuration saw an increase from an initial 11.0% win rate to 38.5%, underscoring the system's enhanced capability to handle numerical disadvantages effectively.

In configurations involving larger groups, such as the 4v4 and 6v6, the system demonstrated even more pronounced enhancements. The 4v4 scenario saw an impressive jump from 44.5% to 92.5%, and the 6v6 configuration saw an increase in the win rate from 62.5% to 97.5%. These increases were not just a reflection of the system's ability to handle equal numbers, but also its adeptness in managing complex tactical situations, as evidenced by the significant increases in win rates in scenarios like 4v6 and 6v8.

Further complexity in the simulations was introduced in larger configurations such as 6v6, 6v7, and 6v8, where elements of imperfect information were incorporated. These elements include diverse non-commercial systems with differing kill probabilities and the unpredictability of opposing force sizes. These factors were used to simulate real-world operational conditions where information might be incomplete or uncertain, challenging the action selectors to adapt and strategize effectively under pressure.

The detailed performance gains shown in FIG. 11 not only demonstrate the effectiveness of the training process involving diverse and incrementally challenging scenarios but also highlight the robustness of incorporating into the autonomous vehicle 100 a trained multi-modal neural network agent 26A, to enable a UAV for example to adapt to complex combat environments where communications could be lost, thereby improving their operational readiness and effectiveness in real-world applications.

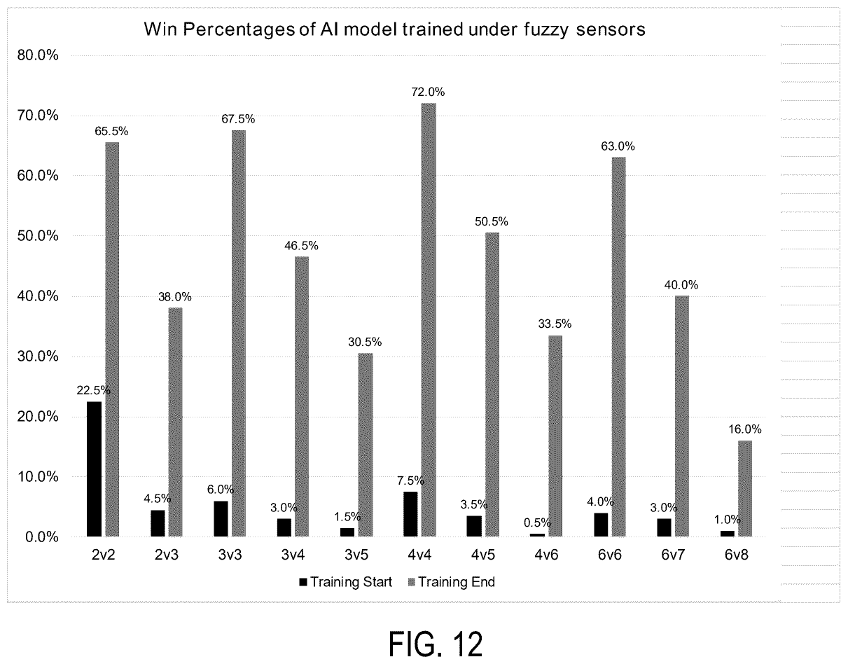

FIG. 12 shows a bar graph detailing the performance improvements achieved by the multi-modal neural network agents 24 of computing system 10 described above, during the course of training in various combat simulation scenarios utilizing simulated fuzzy sensors, which differ from simulated non-fuzzy sensors in that simulated fuzzy sensors provide data with inherent uncertainties and probabilistic values, rather than clear-cut measurements. This means that the information gathered can vary in accuracy, with sensors having a range that might only detect objects with a certain probability, which can decrease from 100% to as low as 30%. This simulates more realistic operational environments where sensor inputs are not always reliable or complete, thus significantly increasing the complexity of decision-making for autonomous systems.

Like the simulations of FIG. 11, the combat scenarios in the simulations of FIG. 12 range from evenly matched configurations (for example, 2v2, where two friendly vehicles combat two enemy vehicles) to more challenging configurations (for example, 6v8, where six friendly vehicles face eight enemies). Each configuration was meticulously evaluated to illustrate the evolving efficacy of the autonomous systems in combat simulations.

The initial and final performance outcomes depicted in FIG. 12 reflect how each team of vehicles adapted to these uncertainties over the course of training. For instance, in the 2v2 scenario, the action selectors improved their win rate from an initial 22.5% to 65.5%, demonstrating significant learning and adaptation despite the challenging sensor inputs. This trend of improvement is consistent across more complex scenarios as well, such as the 2v3 configuration, which saw an increase from 4.5% to 38.0%, and the 3v3 configuration, which increased its performance dramatically from 6.0% to 67.5%.

The graph also shows that as the number of vehicles and the disparity in team sizes increased, the initial win rates tended to be lower, reflecting the greater difficulty of managing more complex engagements with fuzzy sensors. For example, the 4v6 configuration started with a mere 0.5% win rate, improving to 33.5% by the end of training. In the most challenging 6v8 scenario, the action selectors managed to increase their performance from 1.0% to 16.0%, underscoring the steep learning curve and the gradual mastering of strategies needed to cope with high levels of uncertainty and numerical disadvantage.

Moreover, the inclusion of varying non-commercial article ranges with an 80% probability of kill and the unpredictability of opposing force sizes added additional layers of complexity to the simulations. These factors required the action selectors to not only interpret fuzzy sensor data effectively but also to make strategic decisions that accounted for the likelihood of non-commercial article effectiveness and the dynamic nature of enemy forces.

FIG. 12 not only demonstrates the robust training regime that progressively equips the action selectors to handle increasingly complex and uncertain scenarios but also highlights the critical role of fuzzy sensors in training autonomous systems to perform under realistic, imperfect information conditions. The data illustrates how these systems learn and adapt, gradually improving their tactical decision-making and operational effectiveness in simulated combat environments.

Referring to FIGS. 11 and 12, the decentralized actor/centralized critic training algorithm for the multi-modal neural network agents illustrated therein achieved a 92.5% win-rate in 4v4 non-fuzzy sensor setups against the expert system adversary. In fuzzy sensor 4v4 setups the AI achieved a 72% win rate. The 6v6+ air-air combat environment was developed within AFSIM and included multiple aspects of imperfect information such as 1) fuzzy sensors with half the range of perfect sensors and a graduated probability of detect from 100 to 30%, 2) non-commercial articles of various ranges with 80% probability of kill, and 3) unforeseen force sizes during evaluation. Machine learning agents trained against the adversary within 4v4 environment under non-fuzzy and fuzzy setups. Once trained, the machine learning agent was evaluated against the expert system adversary in 11 symmetric and asymmetric force size permutations between 2v2 and 6v8.

The above described systems and methods address the shortcomings of prior approaches to remotely piloted vehicles such as UAVs, by enabling the training of a machine learning model that can act in an autonomous manner to control the vehicle even when communications with a remote pilot are cut. The applicability is not limited UAVs but extends to any remotely operated vehicle that could benefit from an autonomous operation mode. Further, where multiple vehicles are deployed at once, a separate, decentralized machine learning model can be deployed in each vehicle. In fully autonomous modes, machine learning models trained based on simulations as described above offer advantages in terms of decentralized operation that do not rely upon constant communications with a central command center. This has applications in both non-commercial and commercial scenarios, particularly in situations where direct human command runs the risk of being compromised, including non-commercial surveillance or combat patrols, or civilian delivery logistics operations, wildfire patrols, etc. The system leverages a decentralized autonomous control framework, which employs algorithms to enable unmanned vehicles to perform complex tasks and make tactical decisions independently. By integrating this technology, the operational robustness and reliability of unmanned platforms can be increased, facilitating effective mission execution even in the absence of direct human control.

In some embodiments, the methods and processes described herein may be tied to a computing system of one or more computing devices. In particular, such methods and processes may be implemented as a computer-application program or service, an application-programming interface (API), a library, and/or other computer-program product.

The methods and processes described herein are tied to a computing system of one or more computing devices. In particular, such methods and processes can be implemented as a computer-application program or service, an application-programming interface (API), a library, and/or other computer-program product.

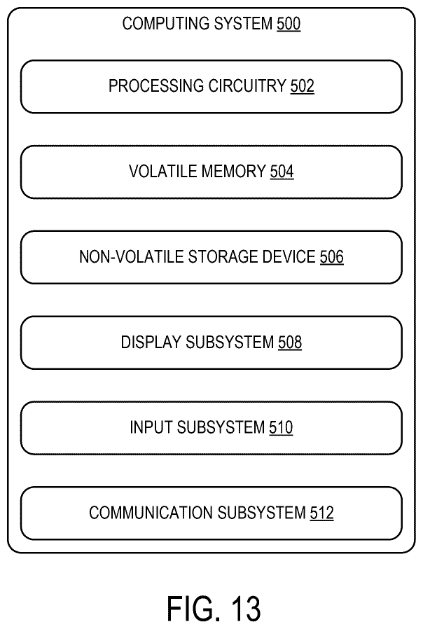

FIG. 13 schematically shows a non-limiting embodiment of a computing system 500 that can enact one or more of the methods and processes described above. Computing system 500 is shown in simplified form. Computing system 500 may embody the computing system 10 described above and illustrated in FIG. 1. Components of computing system 500 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 500 includes processing circuitry 502, volatile memory 504, and a non-volatile storage device 506. Computing system 500 may optionally include a display subsystem 508, input subsystem 510, communication subsystem 512, and/or other components.

Processing circuitry 502 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 502 may be single-core or multi-core, and the instructions executed thereon may be configured for sequential, parallel, and/or distributed processing. Individual components of the processing circuitry 502 optionally may be distributed among two or more separate devices, which may be remotely located and/or configured for coordinated processing. For example, aspects of the computing system 500 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 502.

Non-volatile storage device 506 includes one or more physical devices configured to hold instructions executable by the processing circuitry to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by processing circuitry 502 to temporarily store information during processing of software instructions. It will be appreciated that volatile memory 504 typically does not continue to store instructions when power is cut to the volatile memory 504.

Aspects of processing circuitry 502, volatile memory 504, and non-volatile storage device 506 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via processing circuitry 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device 506, and thus transform the state of the non-volatile storage device 506, the state of display subsystem 508 may likewise be transformed to visually represent changes in the underlying data. Display subsystem 508 may include one or more display devices utilizing virtually any type of technology. Such display devices may be combined with processing circuitry 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem 512 may be configured for communication via a wired or wireless local-or wide-area network, broadband cellular network, etc. In some embodiments, the communication subsystem 512 may allow computing system 500 to send and/or receive messages to and/or from other devices via a network such as the Internet.

The following clauses provide additional description of the systems and methods of the present disclosure.

Example 1. A computerized system is provided comprising processing circuitry and associated memory storing instructions that when executed by the processing circuitry cause the processing circuitry to: execute a multi-agent machine learning model for controlling a plurality of vehicles in a multi-vehicle autonomous control session in a multi-vehicle environment, the multi-agent machine learning model being configured to: at each of a plurality of time steps of the multi-vehicle autonomous control session: at each of a plurality of trained multi-modal neural network agents that each control a corresponding autonomous vehicle in the multi-vehicle autonomous control session: receive multi-modal vehicle state data including image data and parameter data; input the image data to an image feature extractor of the multi-modal neural network agent to thereby produce an image feature vector; input the parameter data through a parameter data feature extractor of the multi-modal neural network agent to thereby produce a parameter data feature vector; concatenate the image feature vector and parameter data feature vector to thereby produce a joint latent representation of the multi-modal vehicle state data; input the joint latent representation to an actor model neural network of the multi-modal neural network agent, to thereby generate a selected action for the autonomous vehicle; and control each autonomous vehicle in the multi-vehicle autonomous control session according to the corresponding selected action for each autonomous vehicle.

Example 2. The computerized system of clause 1, wherein the parameter data includes three dimensional position, heading, and speed for each vehicle.

Example 3. The computerized system of clause 1 or 2, wherein the image data includes a sensor certainty map for a sensor of the vehicle.

Example 4. The computerized system of clause 3, wherein the sensor certainty map is one of a plurality of sensor certainty maps in the image data, each for a respective sensor of the vehicle.

Example 5. The computerized system of any of clauses 1 to 4, wherein the action is selected from the group of candidate actions consisting of a flight control action, deployment action, and countermeasure action.

Example 6. The computerized system of any of clauses 1 to 5, wherein the session is a computer simulation, a hybrid simulation, or a session in a real world environment.

Example 7. The computerized system of any of clauses 1 to 6, wherein each multi-modal neural network agent further includes a centralized critic neural network that is configured to train the corresponding actor neural network by computing a corresponding centralized action-value for the selected action of each actor neural network using a centralized action-value function that takes as input the actions of each actor neural network of each of the plurality of agents.

Example 8. The computerized system of any of clauses 1 to 7, wherein the parameter feature extractor includes a plurality of fully connected layers.

Example 9. The computerized system of clauses 1 to 8, wherein the image feature extractor includes, from input to output, one or more convolutional layers, a pooling layer, one or more additional convolutional layers, another pooling layer, one or more fully connected layers, and a fully connected output layer.

Example 10. The computerized system of clause 9, wherein the vehicles are aircraft and the multi-vehicle environment is a beyond visual range air combat simulation.

Example 11. A computerized method, comprising: at each of a plurality of time steps of a multi-vehicle autonomous control session: at each of a plurality of trained multi-modal neural network agents that each control a corresponding autonomous vehicle in the multi-vehicle autonomous control session: receiving multi-modal vehicle state data including image data and parameter data; inputting the image data to an image feature extractor of the multi-modal neural network agent to thereby produce an image feature vector; inputting the parameter data through a parameter data feature extractor of the multi-modal neural network agent to thereby produce a parameter data feature vector; concatenating the image feature vector and parameter data feature vector to thereby produce a joint latent representation of the multi-modal vehicle state data; inputting the joint latent representation to an actor model neural network of the multi-modal neural network agent, to thereby generate a selected action for the autonomous vehicle; and controlling each autonomous vehicle in the multi-vehicle autonomous control session according to the corresponding selected action for each autonomous vehicle.

Example 12. The computerized method of clause 11, wherein the parameter data includes three dimensional position, heading, and speed for each vehicle.

Example 13. The computerized method of clause 11 or 12, wherein the image data includes a sensor certainty map for a sensor of the vehicle.

Example 14. The computerized method of any of clauses 11 to 13, wherein the action is selected from the group of candidate actions consisting of a flight control action, deployment action, and countermeasure action.

Example 15. The computerized method of any of clauses 11 to 14, wherein the session is a computer simulation, a hybrid simulation, or a session in a real world environment.

Example 16. The computerized method of any of clauses 11 to 15, wherein each multi-modal neural network agent further includes a centralized critic neural network that is configured to train the corresponding actor neural network by computing a corresponding centralized action-value for the selected action of each actor neural network using a centralized action-value function that takes as input the actions of each actor neural network of each of the plurality of agents.

Example 17. The computerized method of any of clauses 11 to 16, wherein the parameter feature extractor includes a plurality of fully connected layers; and

Example 18. The computerized method of any of clauses 11 to 17, wherein the image feature extractor includes, from input to output, one or more convolutional layers, a pooling layer, one or more additional convolutional layers, another pooling layer, one or more fully connected layers, and a fully connected output layer.

Example 19. The computerized method of any of clauses 11 to 18, wherein the vehicles are aircraft and the multi-vehicle environment is a beyond visual range air combat simulation.

Example 20. A computerized system, comprising: a multi-agent machine learning model for controlling a plurality of aircraft in a multi-aircraft autonomous control session in a multi-aircraft beyond visual range air combat environment, the multi-agent machine learning model including a plurality of decentralized actor neural network models and a plurality of centralized critic neural network models, wherein each agent of the multi-agent machine learning model is a multi-modal neural network including an image feature extractor configured to receive an image and extract image features, a parameter feature extractor configured to receive parameters and extract parameter features, an actor neural network model configured to receive a joint representation of the extracted image features and the extracted parameter features, and output a selected action for a corresponding vehicle in the multi-vehicle autonomous control session, and a critic neural network model configured to compute a corresponding centralized action-value using a centralized action-value function that takes as input the actions of all agents.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computerized system, comprising:
processing circuitry and associated memory storing instructions that when executed by the processing circuitry cause the processing circuitry to:
execute a multi-agent machine learning model for controlling a plurality of vehicles in a multi-vehicle autonomous control session in a multi-vehicle environment, the multi-agent machine learning model being configured to:
at each of a plurality of time steps of the multi-vehicle autonomous control session:
at each of a plurality of trained multi-modal neural network agents that each control a corresponding autonomous vehicle in the multi-vehicle autonomous control session:
receive multi-modal vehicle state data including image data and parameter data;
input the image data to an image feature extractor of the multi-modal neural network agent to thereby produce an image feature vector;
input the parameter data through a parameter data feature extractor of the multi-modal neural network agent to thereby produce a parameter data feature vector;
concatenate the image feature vector and parameter data feature vector to thereby produce a joint latent representation of the multi-modal vehicle state data;
input the joint latent representation to an actor model neural network of the multi-modal neural network agent, to thereby generate a selected action for the autonomous vehicle; and
control each autonomous vehicle in the multi-vehicle autonomous control session according to the corresponding selected action for each autonomous vehicle.

2. The computerized system of claim 1, wherein the parameter data includes three dimensional position, heading, and speed for each vehicle.

3. The computerized system of claim 1, wherein the image data includes a sensor certainty map for a sensor of the vehicle.

4. The computerized system of claim 1, wherein the sensor certainty map is one of a plurality of sensor certainty maps in the image data, each for a respective sensor of the vehicle.

5. The computerized system of claim 1, wherein the action is selected from the group of candidate actions consisting of a flight control action, deployment action, and countermeasure action.

6. The computerized system of claim 1, wherein the session is a computer simulation, a hybrid simulation, or a session in a real world environment.

7. The computerized system of claim 1, wherein each multi-modal neural network agent further includes a centralized critic neural network that is configured to train the corresponding actor neural network by computing a corresponding centralized action-value for the selected action of each actor neural network using a centralized action-value function that takes as input the actions of each actor neural network of each of the plurality of agents.

8. The computerized system of claim 1, wherein the parameter feature extractor includes a plurality of fully connected layers.

9. The computerized system of claim 1, wherein the image feature extractor includes, from input to output, one or more convolutional layers, a pooling layer, one or more additional convolutional layers, another pooling layer, one or more fully connected layers, and a fully connected output layer.

10. The computerized system of claim 1, wherein the vehicles are aircraft and the multi-vehicle environment is a beyond visual range air combat simulation.

11. A computerized method, comprising:
at each of a plurality of time steps of a multi-vehicle autonomous control session:
at each of a plurality of trained multi-modal neural network agents that each control a corresponding autonomous vehicle in the multi-vehicle autonomous control session:
receiving multi-modal vehicle state data including image data and parameter data;
inputting the image data to an image feature extractor of the multi-modal neural network agent to thereby produce an image feature vector;
inputting the parameter data through a parameter data feature extractor of the multi-modal neural network agent to thereby produce a parameter data feature vector;
concatenating the image feature vector and parameter data feature vector to thereby produce a joint latent representation of the multi-modal vehicle state data;
inputting the joint latent representation to an actor model neural network of the multi-modal neural network agent, to thereby generate a selected action for the autonomous vehicle; and
controlling each autonomous vehicle in the multi-vehicle autonomous control session according to the corresponding selected action for each autonomous vehicle.

12. The computerized method of claim 11, wherein the parameter data includes three dimensional position, heading, and speed for each vehicle.

13. The computerized method of claim 11, wherein the image data includes a sensor certainty map for a sensor of the vehicle.

14. The computerized method of claim 11, wherein the action is selected from the group of candidate actions consisting of a flight control action, deployment action, and countermeasure action.

15. The computerized method of claim 11, wherein the session is a computer simulation, a hybrid simulation, or a session in a real world environment.

16. The computerized method of claim 11, wherein each multi-modal neural network agent further includes a centralized critic neural network that is configured to train the corresponding actor neural network by computing a corresponding centralized action-value for the selected action of each actor neural network using a centralized action-value function that takes as input the actions of each actor neural network of each of the plurality of agents.

17. The computerized method of claim 11, wherein
the parameter feature extractor includes a plurality of fully connected layers.

18. The computerized method of claim 11, wherein the image feature extractor includes, from input to output, one or more convolutional layers, a pooling layer, one or more additional convolutional layers, another pooling layer, one or more fully connected layers, and a fully connected output layer.

19. The computerized method of claim 11, wherein the vehicles are aircraft and the multi-vehicle environment is a beyond visual range air combat simulation.

20. A computerized system, comprising:
a multi-agent machine learning model for controlling a plurality of aircraft in a multi-aircraft autonomous control session in a multi-aircraft beyond visual range air combat environment, the multi-agent machine learning model including a plurality of decentralized actor neural network models and a plurality of centralized critic neural network models,
wherein each agent of the multi-agent machine learning model is a multi-modal neural network including an image feature extractor configured to receive an image and extract image features, a parameter feature extractor configured to receive parameters and extract parameter features, an actor neural network model configured to receive a joint representation of the extracted image features and the extracted parameter features, and output a selected action for a corresponding vehicle in the multi-vehicle autonomous control session, and a critic neural network model configured to compute a corresponding centralized action-value using a centralized action-value function that takes as input the actions of all agents.
